(19) United States
(12) Patent Application Publication
(10) Pub. No.: US 2020/0122432 A1
(43) Pub. Date: Apr. 23, 2020

(54) COMPOSITIONS FOR DISSIPATING HEAT

(71) Applicant: Rocky Research, Boulder City, NV (US)

(72) Inventors: Uwe Rockenfeller, Boulder City, NV (US); Kaveh Khalili, Boulder City, NV (US)

(21) Appl. No.: 16/168,670

(22) Filed: Oct. 23, 2018

(51) Int. Cl. B32B 15/20; B32B 27/34; B32B 27/28; B32B 5/08

(52) U.S. Cl. CPC B32B 15/20; B32B 27/34; B32B 27/28; B32B 5/08; B32B 2311/00; B32B 2307/416; B32B 2262/106; B32B 2262/0261; B32B 2571/00; B32B 2305/188; B32B 2307/302; B32B 2262/101

(57) ABSTRACT

A heat dissipating shield comprises a layered configuration that mitigates damage to a surface coated with the shield. For example, the shield may comprise a sealant layer and a hydrated complex compound layer, such that the hydrated complex compound releases water vapor when the shield is exposed to heat. The water vapor may escape the shield without damaging the surface being protected by the shield.

### FIELD OF THE INVENTION

This application relates to compositions capable of dissipating heat. In some aspects, the composition comprises a shield that protects a surface from heat exposure.

### BACKGROUND

Heat dissipating compositions may be used in many applications. For example, they may be used to make shields that protect objects from heat. These compositions may absorb directed energy in a chemical reaction without significant increase in temperature, thus mitigating or avoiding a dramatic temperature increase that may be induced by a direct heat source.

### SUMMARY OF THE INVENTION

Aspects of the invention relate to a composition for dissipating heat. In some embodiments, the composition may comprise: a first layer formed from a compacted, hydrated, complex compound, wherein the first layer has a front surface and a back surface, and a sealant applied to the front surface of the first layer, wherein the sealant prevents vapor desorption from the hydrated complex compound until the composition is subjected to a heating event.

In another embodiment, the composition comprises a thermally conductive material disposed adjacent to the first layer. In some embodiments, the thermally conductive layer comprises copper or aluminum. The composition may comprise a second layer formed from the compacted, hydrated complex compound disposed adjacent to the thermally conductive material. The hydrated complex compound may comprise hydroxides or chlorides of alkali or alkali-earth metals or hydrated transition metal halides or hydroxides.

In yet another embodiment, the hydrated complex compound may comprise one or more metal salts or hydroxides, wherein the metal is selected from the group consisting of alkali metal, alkaline earth metal, transition metal, or combinations thereof. The metal salts may comprise ions selected from the group consisting of: halide, nitrite, nitrate, oxalate, perchlorate, sulfate, sulfite, or combinations thereof. The metal salts may comprise one or more metals selected from the group consisting of: strontium, magnesium, manganese, iron, cobalt, calcium, barium, and lithium. In some embodiments, the hydrated complex compound is hydrated with water. The hydrated complex compound may comprise LiOH.1H₂O, Sr(OH)₂.8H₂O, CaCl₂.1H₂O, SrCl₂.6H₂O or CaCl₂.2H₂O. The hydrated complex compound may be bound to a fiber matrix. The fiber matrix may comprise woven, layered, or intertwined strands of fibers. The fiber matrix may comprise glass, polyamide, polyphenylene sulfide, polyparaphenylene terephthalamide, carbon or graphite fibers, or combinations thereof.

In another embodiment, the sealant comprises a polymeric or rubber sealant. In another embodiment, the front surface comprises a reflective material configured to reflect spectral frequencies in the range of 700 nm to 2500 nm.

Another aspect of the invention relates to a heat dissipation panel. In some embodiments, the panel may comprise a first layer formed from a compacted, hydrated, complex compound, a thermally conductive material disposed adjacent the first layer, and a second layer formed from the compacted, hydrated complex compound and disposed adjacent to the thermally conductive material. In some embodiments, the thermally conductive material comprises copper or aluminum.

In another embodiment, the panel may further comprise a sealant applied to a front surface of the first layer, wherein the sealant prevents vapor desorption from the hydrated complex compound until the composition is subjected to heating event. In another embodiment, a front surface of the first layer comprises a reflective material. The reflective material may be configured to reflect spectral frequencies in the range of 700 nm to 2500 nm

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A illustrates a perspective view of an embodiment of a heat dissipating shield having a sealant layer and hydrate complex compound layer.

FIG. 1B illustrates a perspective view of an embodiment of a heat dissipating shield having a sealant layer, a hydrated complex compound layer, and a thermally conductive layer.

FIG. 1C illustrates a perspective view of an embodiment of a heat dissipating shield having a sealant layer, a thermally conductive layer, and a hydrated complex compound layer.

FIG. 2 illustrates a perspective view of an embodiment of a surface with a heat dissipating shield having a sealant layer, a reflective layer, hydrated complex compound layers, and a thermally conductive layer.

FIG. 3A illustrates a cross-sectional view of an embodiment of a surface with a heat dissipating shield having a sealant layer and a hydrated complex compound layer prior to heat exposure.

FIG. 3B illustrates a cross-sectional view of an embodiment of a surface with a heat dissipating shield having a sealant layer and a hydrated complex compound layer during heat exposure.

FIG. 3C illustrates a cross-sectional view of an embodiment of a surface with a heat dissipating shield having a sealant layer and a hydrated complex compound layer as a result of heat exposure.

FIG. 4A illustrates a perspective view of an embodiment of a heat dissipating shield protecting a surface.

FIG. 4B illustrates a cross-sectional view of the embodiment of FIG. 4A, along line 15, having a sealant layer, a hydrated complex compound layer, and a thermally conductive layer.

### DETAILED DESCRIPTION OF THE PREFERRED EMBODIMENT

### I. Introduction

Embodiments of the invention relate to heat dissipating shields. For example, a heat dissipating composition may applied to any surface that needs to be protected from intense heat sources. In one embodiment, the heat dissipation composition may be imbedded within, or adjacent to, an armor material to protect a surface. The heat dissipation composition may be an endothermic material. Upon exposure to heat from a heat source, the composition may absorb the heat and generate water vapor, which is subsequently released from the shield. In this way, the heat is dissipated by the components of the shield rather than causing damage to the protected surface.

### II. Heat Dissipating Shields

Heat shields may protect a surface from damage from a heat source by dissipating, reflecting, or absorbing the heat. In this way, energy from the heat impacts the shield and minimizes impact to the protected surface. Fire, explosives, radiative heat, lasers, and heat guns are among the heat sources that can damage a surface.

Heat from a heat source can cause a heating event on the surface of an object resulting in fire, melting, or exploding of the object. This effect may be exploited in the form of a weapon to inflict intentional damage to an object. Missiles, rockets, rocket motors, rotary and fixed-wing aircraft, drones, mortars, and other ground, sea, air, and space-borne assets and facilities are among the objects that may be prone to damage from directed heat sources.

Heat sources with a capacity in the range of a few kilowatts to around 100 kilowatts may be directed toward ground-based or low altitude target objects. Heat sources with a power density range of a few hundred kilowatts may reach target objects at a further distance, high altitude, or even beyond earth's atmosphere in space. Atmospheric conditions may reduce the heat source intensity that reaches the target.

In addition, the target area of a surface that may be impacted by heat depends on the focus of the heat source. When the heat source is a beam of light, targets that are further away result in a larger and less focused area, which may be referred to as the “bucket.” While light sources with lower power levels may impact targets at distances of a few miles, light sources generating power in the multi-hundred-kilowatt range are expected to reach target objects at a distance of many miles. Light sources with power levels in the range of several hundred kilowatts may be capable of intercepting intercontinental ballistic missiles.

If a light source makes contact with a target, the energy density on the surface of the target may be between about 0.2 kJ/cm² and exceeding 1 kJ/cm². Earlier systems with more limited power and beam focus may deliver energy densities in the lower half of that range.

In one embodiment of the invention, a heat dissipating shield is used on the outer surface of a target object and may employ a structure, such as ceramic or high-tech fiber material that houses an endothermic compound that undergoes an endothermic reaction at a trigger temperature. In some embodiments, the shield also includes a reflecting finish that reflects at least some of the source light. The endothermic compound may be made up of a hydrated complex compound, an organic polymer with large water absorption capability or combinations of such materials.

Examples of hydrated complex compounds that may be used include hydroxides and chlorides of alkali or alkali-earth metals, such as LiOH.1H₂O, CaCl₂.1H₂O, CaCl₂.2H₂O, SrCl₂.6H₂O, Sr(OH)₂.8H₂O, or hydrated transition metal halides or hydroxides. Water is one example of a useful ligand due to its high heat of desorption compared to other polar gases capable of forming a complex compound. A more detailed description of such materials as well as oxide-hydroxide reactions can be found in U.S. Pat. Nos. 8,361,618 and 8,302,416, incorporated herein by reference in their entirety. The hydrated complex compounds may be compacted by a variety of means. For example, compacting may mean adding pressure to a complex compound material sufficient to reduce voids in the material. The pressure may be mild enough to be created by a hand, or strong enough to require a mechanical or hydraulic press. Thus, as used herein, compacting may mean either pressed, melted, or pressed and melted to form a quasi-homogenous mass. In some embodiments, the hydrated complex compounds may melt and/or release their stored water at differing temperatures. For example, SrCl₂.6H₂O may melt at approximately 115 degrees centigrade, but prior to reaching that temperature, become only partially hydrated by releasing stored water.

In some embodiments, the surface to be protected is that of a supersonic or hypersonic such as an airplane or missile. Objects traveling at these speeds may have surface temperatures exceeding 500 degrees centigrade while in motion. For applications of this type, a metal hydroxide compound may be included in the heat dissipating shield. Examples of metal hydroxides that can be used include NaOH, Ca(OH)₂, Sr(OH)₂, Al(OH)₃, Be(OH)₂, Co(OH)₂, Cu(OH)₂, Cm(OH)₃, Au(OH)₃, Fe(OH)₂, Hg(OH)₂, Ni(OH)₂, Sn(OH)ₛ, and Zn(OH)₂.

Reflective materials may coat the surface to be protected. Reflective materials are selected to have maximum reflectivity at the light frequencies that may contact the material. For example, when the light source is a laser, reflectivity in the near infrared range of 700-2,500 nm may be desirable. Silver, aluminum, and gold are examples of reflective materials that may be used within embodiments of the invention.

In order to increase the effectiveness of heat dissipating shields, thermally conductive materials such as high-thermal conductivity carbon or highly conductive metals such as copper or aluminum may be layered on top of, beneath, or embedded into the heat shield's compound to increase the chemical reaction mass reaching the trigger temperature.

The encapsulation of endothermic compounds bound to fibers is also described in the above-mentioned patents. However, encapsulation of the endothermic compounds within a substrate may not be necessary in all circumstances as the thermal shield material itself may not be designed to provide mechanical armor. Removing the encapsulation materials from the structure of the heat shield will reduce weight and thereby increase the thermal energy density of the heat shield.

In one embodiment, the heat shield is configured or designed to have a specific trigger temperature at which the materials are activated to absorb thermal energy. In order to obtain a trigger temperature between the heat shield and applied heat, a sealant may be applied to the surface that maintains a vapor or gas barrier, disabling the desorption process until a certain temperature and therewith a certain pressure is reached.

The sealant may be selected to provide a differential pressure barrier that, once exceeded, allows for the vapor stored within the heat shield to escape, thus facilitating the desorption and thermal absorption. Typical trigger temperatures may be, for example, between 100-150 degrees centigrade, or may be much higher, for example, in excess of 500 degrees centigrade. Such temperatures are not reached during typical storage, transportation, or operation, but may be reached if extreme heat is applied to the heat shield. Embodiments of the heat shield may also include a sealant that undergoes chemical reactions at higher trigger temperatures, such as metal hydroxide to metal oxide reactions.

Example materials for the sealant may include any material that prevents stored water or other vapor within the heat shield composition from escaping the substrate until the trigger temperature is reached. Suitable coating compositions include epoxy resin, phenolic resin, neoprene, vinyl polymers such as PBC, PBC vinyl acetate or vinyl butyral copolymers, fluoroplastics such as polychlorotrifluoroethylene, polytetrafluoroethylene, FEP fluoroplastics, polyvinylidene fluoride, chlorinated rubber, and metal films including steel alloys, aluminum and zinc coatings. The aforesaid list is by way of example, and is not intended to be exhaustive. The coating may be applied to individual layers of substrate, and/or to a plurality of layers or to the outer, exposed surfaces of a plurality or stack of substrate layers. When different sorbents are used each such composition is preferably sealed by sealant to avoid undesired migration of refrigerant from one sorbent to the other or mixing or displacement of one refrigerant with the other. In addition to these sealants, other sealants that provide some mechanical strength and protection of the underlying surface may also be used within embodiments of the invention.

For example, in one embodiment, the sealant is a porous fiber composite, or other composite material having pores that are configured to release vapor once a trigger pressure is reached. Thus, a heat source may be applied to the heat shield, which results in release of bound water from the shield material. Once the pressure of the released water vapor reaches a predetermined trigger pressure, the vapor is released through the pores of the composite sealant. The pressure difference across the porous composite that results in release of trapped vapor from the heat shield may be, for example, 0.1, 0.5, 1, 2, 5, or 10 atmospheres (atm) or more.

In another embodiment, the sealant could be a material that melts at a trigger temperature between about 100-150 degrees centigrade, allowing water vapor to escape, and solidifying upon cooling. Paraffin and other waxes are examples of this type of sealant. Materials with higher melting points may be used for compounds that desorb at temperatures above 150 degrees centigrade, or even above 500 degrees centigrade.

Energy densities for hydrated complex compound or organic polymer desorptions may be in the range of 0.8 kJ/g to over 2 kJ/g. Volumetric energy densities including the structure housing the compound, the compound itself, the sealant, and possible thermal conductivity enhancements may be on the order of 0.6 kJ/cm³ to a little over 1.2 kJ/cm³ in one embodiment.

In one embodiment, the heat shield composition is cut, formed, rolled or pressed to form one or more layers of a desired size and/or shape. Each layer of material may be coated with a sealant composition capable of preventing the penetration of water vapor in the heat shield from escaping out from the complex compound material and through the coating at ambient/atmospheric temperature and pressure. Panels or other forms and geometries such as concave, convex or round shapes of the aforesaid coated substrate composites such as laminates are formed to the desired thickness. Moreover, such panels or laminates may also provide ballistic protection in addition to thermal protection. Such dual-purpose panels may be installed in doors, sides, bottoms or tops of a vehicle, around ammunition, sensitive cargo, etc. to provide such protection as well as the above described cooling properties. Panels may also be shaped for other uses including personnel protection items and may be assembled in the form of cases, cylinders, boxes or containers for protection of ordnance, explosives, rockets, missiles, directed energy, such as laser beams or other material, fragile or sensitive items. Laminates may include layers of steel or other ballistic resistant material such as carbon fiber composites, boron carbide, aramid composites or metal alloys.

For penetration resistant vehicular armor, many different sized and shaped protection panels may be formed of the composite including floor, door, side and top panels as well as vehicle body components contoured in the shape of fenders, gas tank, engine and wheel protectors, hoods, and the like. As used herein, “vehicle” includes a variety of machines, including automobiles, tanks, trucks, helicopters, aircraft and the like. Thus, the penetration resistant vehicle armor may be used to protect the occupants or vital portions of any type of vehicle.

The aforesaid heat shield articles may also be combined with other ballistic and penetration resistant panels of various shapes and sizes. For example, the aforesaid heat shields may be paired with one or more layers or panels of materials such as steel, aramid resins, carbon fiber composites, boron carbide, or other such penetration resistant materials known to those skilled in the art including the use of two or more of the aforesaid materials, depending on the armor requirements of the penetration resistant articles required.

### III. Overview of Example Heat Dissipating Shields

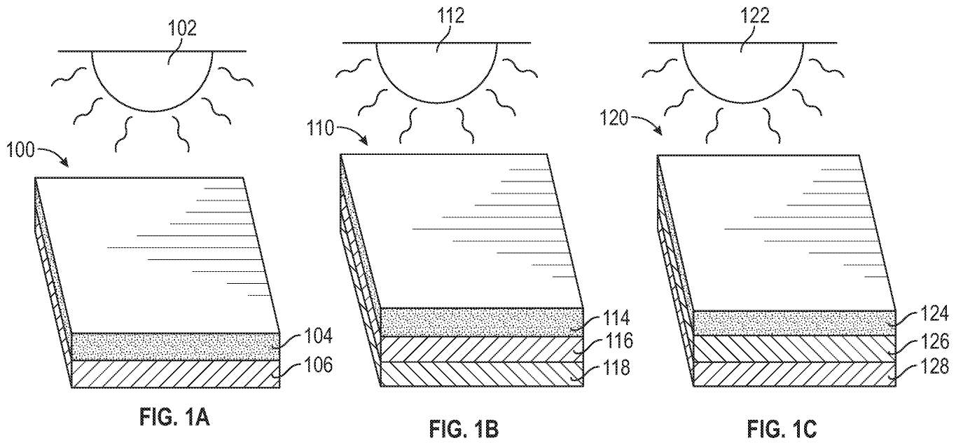

FIG. 1A illustrates an embodiment of a heat shield 100 capable of dissipating heat from heat source 102. As illustrated, the shield 100 can include an upper sealant layer 104 disposed directly adjacent to a hydrated complex compound layer 106. The sealant layer may be made up of any material that can seal stored water or other molecules in the hydrated complex compound layer 106 from escaping until a trigger temperature is reached. In the illustrated embodiment, the complex compound layer 106 does not include a substrate, such as fiber, bound to the complex compounds. Instead, the complex compound layer 106 was formed by compression of the complex compound materials to form a free-standing composition that may be adhered to a surface needing thermal protection.

FIG. 1B illustrates an embodiment of heat shield 110 capable of dissipating heat from heat source 112. As illustrated, the shield 110 can include an upper sealant layer 114 directly adjacent to a hydrated complex compound layer 116. Below the hydrated complex compound layer 116 is a thermal conductive layer, 118. In this example, the thermal conductive layer 118 is a copper layer, although other thermally conductive materials such as aluminum are also contemplated. The thermal conductive layer is configured to spread any heat that is transferred into the heat shield from one focused location to a broader surface of the shield. Thus, a focused source of heat, such as from a laser, would strike the upper layers 114 and 116 of the heat shield and traverse though the composition until reaching the thermal transfer layer 118. At thermal conductive layer 118, the heat from the laser would be conducted laterally through the device 110 such that the heat is spread out across a larger surface area and not focused on a small, specific region. This spreading out of the thermal energy would allow the heat shield 110 to absorb a relatively large amount of focused thermal energy and diffuse that energy through a broader area of the heat shield to help prevent too much focused thermal energy from specifically contacting a protected surface.

FIG. 1C illustrates an embodiment of heat shield 120 capable of dissipating heat from heat source 122. As illustrated, the shield 120 can include an upper sealant layer 124 directly adjacent to a thermally conductive layer 126. Below the thermally conductive layer 126 is a hydrated complex compound layer 128.

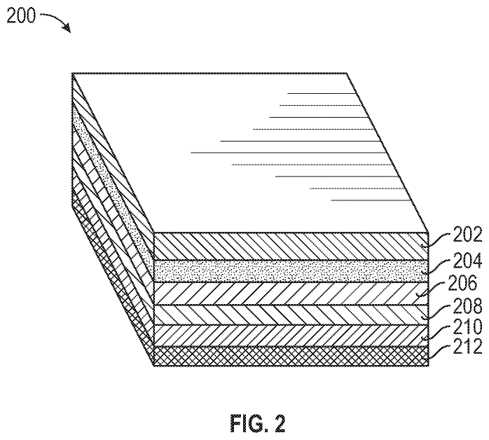

FIG. 2 illustrates a multi-layered heat shield 200 that includes a lower protected surface 212 that is coated with the heat shield compositions in order to be capable of dissipating heat from a heat source. As illustrated, the shield layers that are protecting the surface 212 can include an upper sealant layer 202 as described previously and configured to face a potential heat source. Below the sealant layer 202 is a reflective surface 204. The reflective surface 204 is made from aluminum in this example, although other reflective materials such as gold are also contemplated.

Located below the reflective surface is a first hydrated complex compound layer 206. The first hydrated complex compound layer 206 is made from a compressed formulation of LiOH.1H₂O in this example, and formed into a rectangular shape to match the shape of the protected surface 212. Of course, it should be realized that these components may be formed in any desired shape.

Located below the first hydrated complex compound layer 206 is a thermal conductive layer 208. The thermal conductive layer 208 is disposed below, and in thermal contact with, the first hydrated complex compound layer 206. In this example, the thermal conductive layer 208 is a copper layer, although other thermally conducted materials such as aluminum are also contemplated. Disposed below the thermal conductive layer 208 is a second hydrated complex compound layer 210. The first hydrated complex compound layer 206 and the second hydrated complex compound layer 210 may be made from the same materials or a different set of materials in order to provide the desired heat dissipation characteristics for the heat shield 200. For example, the first hydrated complex compound layer 206 may be formed from compressed LiOH.1H₂O and the second hydrated complex compound layer 210 may be formed from compressed CaCl₂.1H₂O.

Although the complex compound layers 206 and 210 are described as compressed layers of hydrated complex compounds, it should be realized that they also may be made from layers of complex compounds that are bound to some type of substrate, such as a fiber strands. Furthermore, compression may be minimal and a combination of melt and compression may be used to obtain the final configuration of the endothermic mass.

The substrate material of which the fiber strands are made include glass, polyamide, polyphenylene sulfide, polyparaphenylene terephthalamide, carbon, or graphite fibers. The glass fibers may be E-glass and/or S-glass, the latter having a higher tensile strength. Glass fiber fabrics are also available in many different weaving patterns which also makes the glass fiber material a good candidate for the composites. Carbon and/or graphite fiber strands may also be used. Polyamide materials or nylon polymer fiber strands are also useful, having good mechanical properties. Aromatic polyamide resins (aramid resin fiber strands, commercially available as Kevlar® and Nomex®) are also useful. Yet another useful fiber strand material is made of polyphenylene sulfide, commercially available as Ryton®. Combinations of two or more of the aforesaid materials may be used in making up the substrate, with specific layered material selected to take advantage of the unique properties of each of them. The substrate material, preferably has an open volume of at least about 30%, and more preferably above 50%, up to about 95%. The specific substrate material selected and used as well as the percentage of open volume may depend on the expected uses, including environmental exposure conditions, substrate melting temperatures, and the like.

The surface of the fibers and fiber strands of the aforesaid substrate material are sufficiently polarized to at least provide some bonding between the fiber and the absorbent hydrated complex compound adequate to achieve the below loading densities. Polarized fibers are commonly present on commercially available fabrics, weaves or other aforesaid forms of the substrate. If not, the substrate may be treated to polarize the fiber and strand surfaces. The surface polarization requirements of the fiber, whether provided on the substrate by a manufacturer, or whether the fibers are treated for polarization, should achieve a target loading density of the metal salt or hydroxide on the fiber. In one example, the loading density of hydrated complex compound is at least about 0.3 grams per cc of open substrate volume whereby the bonded metal compound bridges at least some adjacent fiber and/or adjacent strands of the substrate.

Polarity of the substrate material may be readily determined by immersing or otherwise treating the substrate with a solution of the salt or hydroxide, drying the material and determining the weight of the metal compound polar bonded to the substrate. Alternatively, polar bonding may be determined by optically examining a sample of the dried substrate material and observing the extent of metal compound bridging of adjacent fiber and/or strand surfaces. Even prior to such bonding determination, the substrate may be examined to see if excessive oil or lubricant is present on the surface. Oil coated material may negatively affect the ability of the substrate fiber surfaces to form an ionic, polar bond with a metal salt or metal hydroxide. If excessive surface oil is present, the substrate may be readily treated, for example, by heating the material to sufficient temperatures to burn off or evaporate most or substantially all of the undesirable lubricant. Oil or lubricant may also be removed by treating the substrate with a solvent, and thereafter suitably drying the material to remove the solvent and dissolved lubricant. Substrates may also be treated with polarizing liquids such as water, alcohol, inorganic acids, e.g., sulfuric acid.

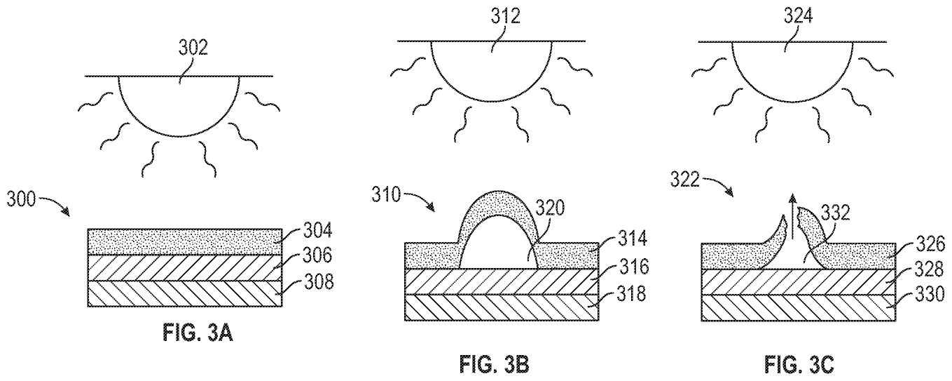

FIG. 3A illustrates an embodiment 300 of surface 308 coated with a shield capable of dissipating heat from heat source 302, prior to heat from the heat source coming into contact with the shield. As illustrated, the shield can include sealant layer 304 and a hydrated complex compound layer 306.

FIG. 3B illustrates an embodiment 310 of surface 318 coated with a shield capable of dissipating heat from heat source 312, while the shield is exposed to heat from the heat source. As illustrated, the shield can include sealant layer 314 and a hydrated complex compound layer 316. During heat exposure, vapor 320 generates pressure between sealant layer 314 and hydrated complex compound layer 316. In this example, the vapor creates a cavity between the sealant layer and the hydrated complex compound layer. Of course, the vapor may form within the shield without causing any cavitation.

FIG. 3C illustrates an embodiment 322 of surface 330 coated with a shield capable of dissipating heat from heat source 324, after the shield is exposed to heat from the heat source. As illustrated, the shield can include a sealant layer 326 and hydrated complex compound layer 328. After heat exposure from the heat source, vapor 332 that was generated during heat exposure may put pressure on sealant layer 326, causing the sealant layer to release the vapor through pores in the sealant layer, or alternatively rupture and allow the vapor to escape, as indicated by the arrow pointing away from the shield in FIG. 3C. When the sealant is a wax, heat may cause it to melt, allowing vapor to escape through the melted wax. When the wax cools, it may re-solidify into a hardened sealant layer. In one embodiment, the sealant layer is chosen to have a predetermined pore size which is calculated to release vapor when the pressure below the sealant layer reaches a predetermined value.

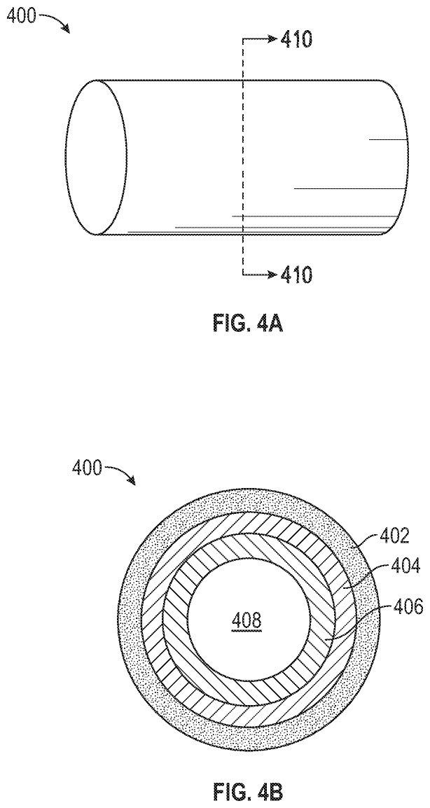

FIG. 4A illustrates embodiment 400 of a cylindrical heat dissipating shield protecting a surface. A cross-section of embodiment 400 along line 410 is illustrated in FIG. 4B. As illustrated, protected surface 408 is adjacent to thermally conductive layer 406. Hydrated complex compound layer 404 completely coats thermally conductive layer 406. Outermost layer 402 is a sealant layer that completely coats hydrated complex compound layer 404.

It should be realized that the shield may be molded into any desired shape or configuration to thermally protect a surface. For example, the shield may be molded into a cylindrical, conical, spherical, or other shape yet having the same configuration of specific layers as shown in the Figures.

### IV. Other Embodiments

Although discussed herein primarily in the context of heat dissipation, it will be appreciated that the compositions described above can be implemented in a variety of other circumstances. The compositions can also be implemented as body armor, for example as a protective layer for a person to wear while welding, glass-blowing or while participating in other activities that involve intense heat sources.

Features, materials, characteristics, or groups described in conjunction with a particular aspect, embodiment, or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure.

Although the present disclosure includes certain embodiments, examples and applications, it will be understood by those skilled in the art that the present disclosure extends beyond the specifically disclosed embodiments to other alternative embodiments and/or uses and obvious modifications and equivalents thereof, including embodiments which do not provide all of the features and advantages set forth herein. Accordingly, the scope of the present disclosure is not intended to be limited by the specific disclosures of preferred embodiments herein, and may be defined by claims as presented herein or as presented in the future.

What is claimed is:

1. A composition for dissipating heat, comprising:
a first layer formed from a compacted, hydrated, complex compound, wherein the first layer has a front surface and a back surface; and
a sealant applied to the front surface of the first layer, wherein the sealant prevents vapor desorption from the hydrated complex compound until the composition is subjected to a heating event.

2. The composition of claim 1, wherein the composition comprises a thermally conductive material disposed adjacent to the first layer.

3. The composition of claim 2, wherein the thermally conductive layer comprises copper or aluminum.

4. The composition of claim 2, wherein the composition comprises a second layer formed from the compacted, hydrated complex compound disposed adjacent to the thermally conductive material.

5. The composition of claim 1, wherein the hydrated complex compound comprises hydroxides or chlorides of alkali or alkali-earth metals or hydrated transition metal halides or hydroxides.

6. The composition of claim 1, wherein hydrated complex compound comprises one or more metal salts or hydroxides, wherein the metal is selected from the group consisting of alkali metal, alkaline earth metal, transition metal, or combinations thereof.

7. The composition of claim 6, wherein the metal salts comprise ions selected from the group consisting of: halide, nitrite, nitrate, oxalate, perchlorate, sulfate, sulfite, or combinations thereof.

8. The composition of claim 7, wherein the metal salts comprise one or more metals selected from the group consisting of: strontium, magnesium, manganese, iron, cobalt, calcium, barium, and lithium.

9. The composition of claim 1, wherein the hydrated complex compound comprises LiOH.1H₂O, Sr(OH)₂.8H₂O, CaCl₂.1H₂O, SrCl₂.6H₂O or CaCl₂.2H₂O.

10. The composition of claim 1, wherein the hydrated complex compound comprises a metal salt hydrated with water.

11. The composition of claim 1, wherein the sealant comprises a polymeric or rubber sealant.

12. The composition of claim 1, wherein the front surface comprises a reflective material configured to reflect spectral frequencies in the range of 700 nm to 2500 nm.

13. The composition of claim 1, wherein the compacted, hydrated, complex compound is bound to a fiber matrix.

14. The composition of claim 13, wherein the fiber matrix comprises woven, layered, or intertwined strands of fibers.

15. The composition of claim 13, wherein the fiber matrix comprises glass, polyamide, polyphenylene sulfide, carbon or graphite fibers, or combinations thereof.

16. A heat dissipation panel, comprising:
a first layer formed from a compacted, hydrated, complex compound;
a thermally conductive material disposed adjacent the first layer; and
a second layer formed from the compacted, hydrated complex compound and disposed adjacent to the thermally conductive material.

17. The heat dissipation panel of claim 16, further comprising a sealant applied to a front surface of the first layer, wherein the sealant prevents vapor desorption from the hydrated complex compound until the composition is subjected to heating event.

18. The heat dissipation panel of claim 16, wherein the thermally conductive material comprises copper or aluminum.

19. The heat dissipation panel of claim 16, wherein a front surface of the first layer comprises a reflective material.

20. The heat dissipation panel of claim 19, wherein the reflective material is configured to reflect spectral frequencies in the range of 700 nm to 2500 nm
